(19) United States
(12) Patent Application Publication
(10) Pub. No.: US 2006/0127565 A1
(43) Pub. Date: Jun. 15, 2006

(54) Method for microstructuring by means of locally selective sublimation

(75) Inventors: Eike Becker, Braunschweig (DE); Dirk Heithecker, Braunschweig (DE); Dirk Metzdorf, Braunschweig (DE); Hermann Hans Johannes, Vechelde (DE); Thomas Dobbertin, Braunschweig (DE); Daniel Schneider, Braunschweig (DE); Wolfgang Kowalsky, Braunschweig (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: NOKIA CORPORATION, ESPOO (FI)

(21) Appl. No.: 10/530,255

(22) PCT Filed: Oct. 1, 2003
(86) PCT No.: PCT/EP03/10863

§ 371 Date: Oct. 19, 2005

(30) Foreign Application Priority Data
Oct. 4, 2002 (DE) 102-46-425.1

(51) Int. Cl. B05D 5/06; B05D 5/12

(52) U.S. Cl. 427/66; 427/70

(57) ABSTRACT

A method for microstructuring by means of locally selective sublimation is disclosed, whereby patterns or images of organic electroluminescent components are produced by application of low molecular weight emission material, provided on a support, to those points of substrate corresponding to the pattern or image for production, by means of sublimation. According to the invention, the method is carried out by firstly completely coating a film support made from temperature-resistant material with the emission material. The coated support and the substrate are then placed adjacent and parallel to each other in a vacuum chamber. The side of the support coated with the emission material faces the substrate. The support is subsequently locally heated for a short period of time on the non-coated side thereof in those positions corresponding to the pattern or image for generation, to a temperature adequate for the sublimation of the emission material.

The invention concerns a method for microstructuring by means of locally selective sublimation, whereby patterns or images of organic electroluminescent components are applied by means of sublimation to a low molecular emissions material provided on a support, to those points of a substrate which correspond to the pattern or image to be produced (US-Z “Applied Physics Letters” vol. 74, no. 13, Mar. 29, 1999, pages 1913 to 1915).

Such a method is used to advantage for the production of displays. Beyond that it can also be used for example to produce laser structures or modular structures based on organic materials. A display is composed of individual picture points “pixels” which can be individually controlled electrically, and are used to display any desired patterns or images. Displays are used for example as a visual interface between man and machine. They can also be computer monitors or mobile telephones. Since the method for microstructuring is essentially performed in the same way for all indicated applications, the following indications refer to the production of displays and represent all other application possibilities.

The displays can be single color or multicolor as well. So-called RGB displays comprise the three colors red, green and blue. When an electric voltage is applied to a display, the electroluminescent components contained therein begin to give off light.

For example an “Organic Light Emitting Diode” is an organic electroluminescent component, hereafter simply called “OLED”. OLEDs have great advantages for the production of patterns on flat supports, so-called displays, namely due because of relatively simple construction and because noncrystalline materials are used. These advantages apply particularly to other types of displays, such as liquid crystal displays or cathode-ray tubes. OLEDs can be made of polymer (PLED) or of low-molecular (SMOLED) organic materials.

The methods for producing OLEDs from PLEDs and SMOLEDs are well known. Materials that can be used for PLEDs are applicable for example in dissolved form next to each other by means of printing techniques (inkjet, silk screen) in an additive process. This is not possible for SMOLEDs. These are produced with known techniques by sublimating the respective materials from evaporative sources in a high vacuum. In that case the sublimated material is precipitated during the gas phase as a thin film over the entire surface of a substrate. The formation of a film over the entire surface by means of this technique is usually only possible at great expense, since the low-molecular materials being used can be easily damaged. An interruption of the vacuum to bring about this formation also reduces the quality of the SMOLEDs drastically. This applies even more to full-color displays, where each picture point requires the separation of three closely adjacent pixels with the emission colors of red, green and blue. In addition it must be ensured that the local application of the different pixels or organic layers can be done without damaging any of the existing layers.

To that end the known method according to the above mentioned US-Z “Applied Physics Letters” uses masks called “shadow masks”. In that case the display substrate is covered with a mask before the organic material is sublimated. The mask is placed at a small distance from the front of the substrate. It only contains openings where a pixel of the organic material is to be produced. Materials for different colors can also be selectively applied by shifting the mask with respect to the substrate the distance of one pixel between sublimation steps. Because of the necessary high dissolution of the matrix structure, any mask used for this method must have a very fine grid. The mask furthermore must have a slender material thickness. Both requirements only provide a low mechanical stability to the mask. This makes the exact positioning and affixing of the mechanically unstable mask difficult, particularly for larger displays. The constant precipitation of sublimated material on the mask also causes its openings to become rapidly clogged, making frequent mask cleaning or mask changing necessary.

The object of the invention is to simplify the above described method. This object is achieved by the invention in that:
first a film support made from a temperature resistant material is completely coated with the emissions material,
then the coated support and the substrate are placed closely adjacent and parallel to each other in a vacuum chamber, where the side of the support that is coated with the emissions material faces the substrate, and
the local positions on the uncoated side of the support which correspond to the pattern or image to be produced are then briefly heated to a temperature that is sufficient for the sublimation of the emissions material.

With this method a film, hereafter called a “film support”, made of a temperature resistant material such as polyimide for example, is first completely coated with an emissions material. To selectively transfer the emissions material to the substrate provided for storing a pattern or image, hereafter called a “display substrate”, it is then placed in a vacuum chamber at a small distance from the film support so that the side coated with the emissions material faces the display substrate. By briefly and locally heating the uncoated side of the film support the emissions material is sublimated and deposited on the display substrate. Because of the small distance between the film support and the display substrate, in this case the expansion of the area that is coated with the material corresponds very accurately to the expansion of the heated area.

The film support can be very quickly and cost-effectively coated with the organic material to be sublimated when simple methods are used. For example if layers of different organic materials are applied to successive areas of the film support, simply advancing the film support between two sublimation steps allows stacks of organic layers, or adjacent pixels with the appropriate control of the heating elements, to be produced with different emissions colors in an uninterrupted process. However separate film supports can also be used if they are coated with the different organic materials and are successively placed into position.

The thin organic layer of emissions materials and the film support carrying it have a low heat capacity. The local heating including the full transfer of the emissions material to the display substrate can then happen within fractions of seconds. Since the local heating takes place in small delimited areas, this method allows to achieve a high lateral dissolution. The local heating can be accomplished with fine-structured electrical heating elements, or with laser radiation in conjunction with the corresponding optics. As already mentioned, in both cases the transfer of the structure can take place simultaneously for all pixels, and consecutively for individual columns or pixels as well. No mechanical moving parts are needed in the vacuum chamber when electrical heating elements or any optical-radiational heating are used.

To adjust the emissions color the film support can also be coated with two successive low-molecular layers, a material A on one side and a material B on the other. The material A is called the host material and material B is the guest material. The two materials are not intermixed on the film support. A mixed layers is created on the display substrate after the sublimation step, where the material A is doped with the material B. The material B produces a light emission. The material B determines the respective emissions color.

The method according to the invention is explained as an embodiment by means of the drawings, wherein:

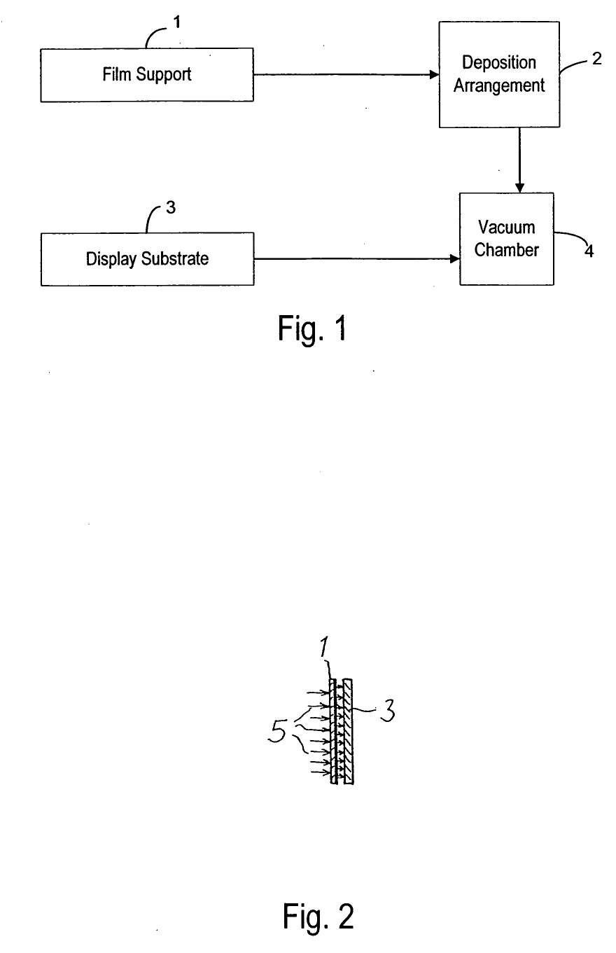

FIG. 1 schematically shows a process of the method according to the invention.

FIG. 2 shows the film support and display substrate arrangement during the course of the process.

A film support 1 made of a temperature resistant material, polyimide for example, is moved to an arrangement 2 where an emissions material is deposited on one of its sides by means of sublimation. The other side of the film support 1 remains uncoated. A thin adhesive layer of the emissions material completely covers the corresponding side of the film support 1. The film support 1 can have a thickness of about 100 ìm for example. It can also be made of a different temperature resistant material than polyimide. The layer of emissions material can be about 10 nm-1 ìm thick. The arrangement 2 can be a high vacuum chamber with the usual sublimation sources. But it can also be arranged as a dipping, spraying or printing device. The emissions material is a low-molecular organic material, such as for example aluminum-tris (8-hydroxyquinoline) (briefly: Alq₃, emissions color green) or with 4-dicyanomethylene)-2-methyl-6-(p-dimethylamine-styrene)-4H-pyran (briefly: DCM) doped Alq₃ (which then becomes DCM: Alq₃, emissions color red), or 2,2′,7,7′-tetrakis (2,2′-diphenylvinyl)spiro-9,9′-byfluorine (briefly: Spiro-DPV-Bi, emissions color blue).

The film support 1 coated with the emissions material and a display substrate 3 are placed in a vacuum chamber 4. There the film support 1 and the display substrate 3 are positioned closely adjacent and parallel to each other as shown in FIG. 2. Their distance from each other is between about 5 ìm and 200 ìm in accordance with the scale of the desired dissolution. A preferred method uses a distance of 50 ìm for example.

Before the emissions material is applied to predetermined areas of the display substrate 3, the back side of film support 1 is briefly and locally heated as shown by the arrows 5. The emissions material is then deposited on the display substrate 3 by means of sublimation. Temperatures between 100° C. and 500° C. can be used. The local heating can be achieved with fine-structured electrical heating elements, or with laser radiation or intense lamp radiation, for example with halogen lamps, in conjunction with the corresponding optics. In both cases the transfer of the structure can take place simultaneously for all pixels and consecutively for individual columns or pixels as well. The expansion of the area that is thereby coated with the emissions material corresponds very accurately to the expansion of the heated area because of the small distance between the film support 1 and the display substrate 3.

A film support 1 coated with the desired emissions material is used to produce single color displays. Full color RGB displays require the use of three film supports 1, each of which is coated with an emissions material. The film supports 1 are then successively placed in the correct position with respect to the display substrate 3 and heated locally. However it is also possible to coat adjacent areas of a film support 1 with different emissions materials. The film support 1 then only needs to be shifted accordingly during the sublimation steps.

To adjust the emissions color, the film support 1 can also be coated with low-molecular materials in two consecutive steps so that the materials are not intermixed. These are for example a host material A and a guest material B which differs from the former. The sublimation step produces a mixed layer on the display substrate 3 where the host material A is doped with the guest material B. The guest material B produces a light emission and determines the emissions color.

Beyond that the method can also be used for low-molecular materials which improve the transport or the injection of electrical charge carriers. A suitable material is for example 4,4′,4″-tris (N-(1-naphthylamine)-N-phenylamine)-triphenylamine (briefly: TNATA, pin feed material).

1. A method for microstructuring by means of locally selective sublimation, where patterns or images of organic electroluminescent components are produced by applying a low-molecular emissions material on a support by means of sublimation to the areas of a substrate which correspond to a pattern or image to be produced, characterized in that
first a film support (1) made from a temperature resistant material is completely coated with the emissions material,
the coated support (1) and the substrate (3) are then placed closely adjacent and parallel to each other in a vacuum chamber (4), where the side of the support (1) that is coated with the emissions material faces the substrate (3), and
on the side of the support (1) that is not coated, the areas corresponding to the pattern or image to be produced on the substrate (3) are then briefly and locally heated to a temperature that is sufficient for the sublimation of the emissions material.

2. A method as claimed in claim 1, characterized in that a polyimide film is used for the support (1).

3. A method as claimed in claim 1 or 2, characterized in that the support (1) is coated with two or more consecutive low-molecular layers in a way so that the different materials of the layers are not intermixed, while they form a mixed layer on the substrate (3) after the sublimation step.

4. A method as claimed in one of claims 1 to 3, characterized in that a structured electrical heating element is used to heat the support (1) locally.

5. A method as claimed in one of claims 1 to 3, characterized in that laser radiation or lamp radiation in conjunction with the corresponding optics are used to heat the support (1) locally.

6. A method as claimed in claim 1, characterized in that the low-molecular material is composed of materials which improve the transport or the injection of electrical charge carriers.
